(19) United States
(12) Patent Application Publication
(10) Pub. No.: US 2023/0319239 A1
(43) Pub. Date: Oct. 5, 2023

(54) NETWORK SYSTEM, INFORMATION PROCESSING METHOD, AND CONTROL DEVICE

(71) Applicant: JOHNAN Corporation, Uji-shi (JP)

(72) Inventors: Kozo MORIYAMA, Kyoto (JP); Shin KAMEYAMA, Kyoto (JP); Truong Gia VU, Kyoto (JP); Lucas BROOKS, Kyoto (JP)

(21) Appl. No.: 18/188,302

(22) Filed: Mar. 22, 2023

(30) Foreign Application Priority Data
Mar. 29, 2022 (JP) 2022-052958

(51) Int. Cl. H04N 7/18

(52) U.S. Cl. CPC H04N 7/183

(57) ABSTRACT

Provided herein is a network system that includes a wearable terminal having a camera and wearable by a user and a control device capable of communicating with the wearable terminal. The wearable terminal transmits the image captured by the camera to the control device. The control device determines whether or not a predetermined information has been viewed by the user based on the image.

### BACKGROUND OF THE INVENTION

### Field of the Invention

The present invention relates to a technology for using a wearable terminal having a camera.

### Description of the Related Art

A wearable terminal having a camera is known. For example, Japanese Patent Laying-Open No. 2012-205163 discloses a wearable camera. It comprises a camera section having an imaging lens and an imaging element. A camera processing unit has a control unit connected to the camera unit and an alarm output unit connected to the control unit. The control unit transmits a dirt detection output to the alarm output unit when dirt is detected on the front part of the imaging lens.

### SUMMARY OF INVENTION

An object of the present invention is to provide a network system capable of determining whether or not a user has visually recognized predetermined information.

According to a certain aspect of the present invention, there is provided a network system that includes a wearable terminal having a camera and wearable by a user and a control device capable of communicating with the wearable terminal. The wearable terminal transmits the image captured by the camera to the control device. The control device determines whether or not a predetermined information has been viewed by the user based on the image.

The present invention has enabled providing a network system capable of determining whether or not a user has visually recognized predetermined information.

### BRIEF DESCRIPTION OF THE DRAWINGS

FIG. 1 is an image diagram showing the overall configuration of a network system according to the first embodiment.

FIG. 2 is a block diagram of the configuration of the control device according to the first embodiment.

FIG. 3 is a block diagram of a configuration of the wearable terminal according to the first embodiment.

FIG. 4 is a block diagram showing the configuration of the display device according to the first embodiment.

FIG. 5 is a block diagram showing the configuration of the robot according to the first embodiment.

FIG. 6 is a flow chart showing a visual recognition determination process according to the first embodiment.

FIG. 7 is a flow chart showing visual recognition determination processing according to the third embodiment.

FIG. 8 is a flow chart showing visual recognition determination processing according to the fourth embodiment.

FIG. 9 is a flow chart showing visual recognition determination processing according to the fifth embodiment.

FIG. 10 is a flow chart showing visual recognition determination processing according to the sixth embodiment.

### DESCRIPTION OF THE PREFERRED EMBODIMENTS

Embodiments of the present invention are described below with reference to the accompanying drawings. In the following descriptions, like elements are given like reference numerals. Such like elements will be referred to by the same names, and have the same functions. Accordingly, detailed descriptions of such elements will not be repeated.

### First Embodiment

### Overall Configuration and Brief Overview of Operation of Network System 1

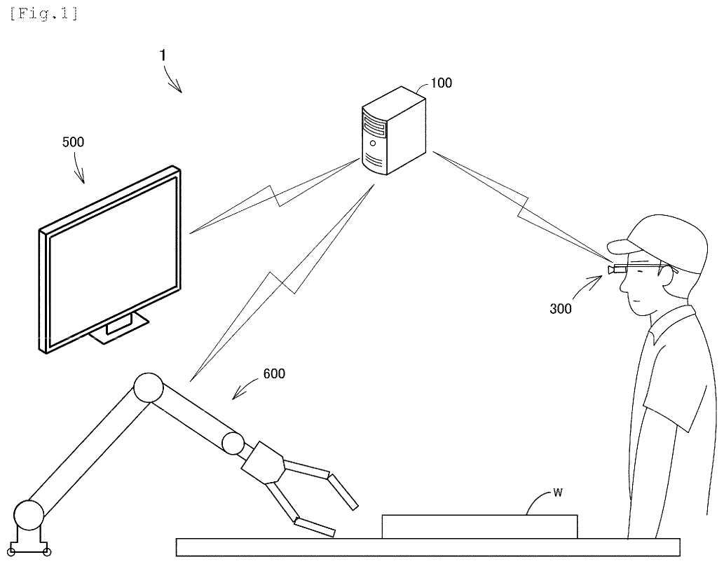

An overall configuration and operation overview of a network system 1 according to an embodiment of the invention is described below, with reference to FIG. 1. Network system 1 according to the present embodiment includes, mainly, a control device 100, a wearable terminal 300, and a display device 500. The network system 1 may include a robot 600 or the like that supports the worker.

The display device 500 is connected to the control device 100, via a wired LAN, wireless LAN, or mobile communication network. The display device 500 displays still images and moving images based on data from the control device 100.

The wearable terminal 300 can be worn on the head of a worker or a user like glasses. The wearable terminal 300 has a camera and transmits a captured image to control device 100.

The robot 600 performs various tasks based on commands from the control device 100 or according to its own judgment.

The control device 100 performs data communication with the wearable terminal 300, the display device 500, and the robot 600, via a wired LAN, wireless LAN, or mobile communication network. In particular, in the present embodiment, the control device 100 causes the display device 500 to display the first information to be presented to the user. The control device 100 acquires a captured image from wearable terminal 300. When the control device 100 determines that the first information appears in the captured image, the control device 100 determines that the user has visually recognized the first information, and proceeds to the next process.

As described above, in the present embodiment, it is possible to determine whether or not the user has visually recognized specific information displayed on display device 500, and to proceed to the next process based on the determination result. The configuration and operation of each part of the network system 1 will be described in detail below.

### Configuration of Control Device 100

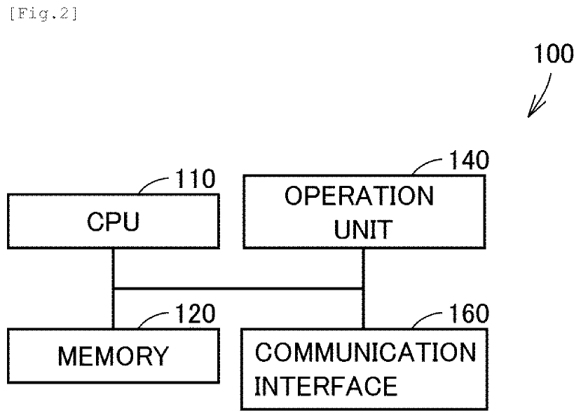

One aspect of the configuration of the control device 100 included in the network system 1 according to the present embodiment will be described. Referring to FIG. 2, control device 100 includes a CPU (Central Processing Unit) 110, a memory 120, an operation unit 140, and a communication interface 160 as main components.

CPU 110 controls each part of control device 100 by executing a program stored in memory 120. For example, CPU 110 executes a program stored in memory 120 and refers to various data to perform various processes described later.

Memory 120 is realized by, for example, various types of RAMS (Random Access Memory) and ROMs (Read-Only Memory). The memory 120 may be included in the control device 100 or may be detachable from various interfaces of the control device 100. The memory 120 may be realized by a recording medium of another device accessible from the control device 100. The memory 120 stores programs executed by the CPU 110, data generated by the execution of the programs by the CPU 110, data input from various interfaces, other databases used in this embodiment, and the like.

Operation unit 140 receives commands from users and administrators and inputs the commands to the CPU 110.

Communication interface 160 transmits data from CPU 110 to display device 500, robot 600, and wearable terminal 300 via a wired LAN, wireless LAN, mobile communication network, or the like. Alternatively, communication interface 160 receives data from display device 500, robot 600, or wearable terminal 300 and transfers the data to CPU 110.

### Configuration of Wearable Terminal 300

Next, one aspect of the configuration of the wearable terminal 300 included in the network system 1 will be described. Wearable terminal 300 according to the present embodiment may have the form of glasses, or may be a communication terminal with a camera that can be attached to a hat or clothes.

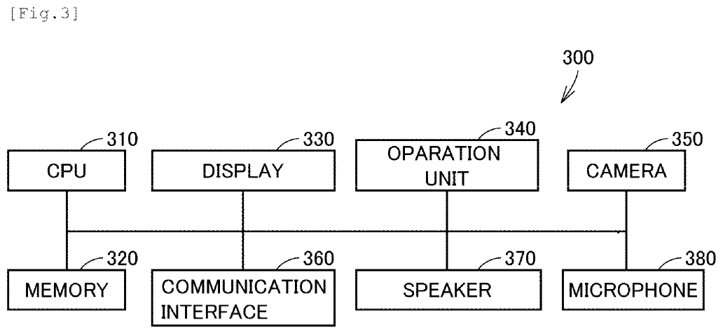

Referring to FIG. 3, wearable terminal 300 according to the present embodiment includes, as main components, CPU 310, memory 320, display 330, operation unit 340, camera 350, communication interface 360, speaker 370, microphone 380 and the like. The camera 350 of this embodiment is a three-dimensional depth camera. Camera 350 may be a conventional two-dimensional camera.

CPU 310 controls each unit of wearable terminal 300 by executing programs stored in memory 320.

Memory 320 is realized by, for example, various types of RAMS and ROMs. Memory 320 stores various application programs, data generated by execution of programs by CPU 310, data received from control device 100, data input via operation unit 340, image data captured by camera 350, and the like.

Display 330 is held in front of the right eye and/or left eye of the user who is wearing the wearable terminal 300 by various structures. Display 330 displays images and text based on data from CPU 310.

Operation unit 340 is composed of buttons, switches, and the like. The operation unit 340 inputs various commands input by the user to the CPU 310.

Camera 350 captures still images and moving images based on instructions from CPU 310 and stores image data in memory 320.

Communication interface 360 transmits and receives data to and from other devices such as control device 100 via a wired LAN, wireless LAN, mobile communication network, or the like. For example, communication interface 360 receives a photographing command from control device 100 and transmits the photographed image data in memory 320 to control device 100 according to an instruction from CPU 310.

Speaker 370 outputs various sounds based on signals from CPU 310. CPU 310 may audibly output various voice messages received from control device 100. The CPU 110 also causes the display 330 to output various information.

Microphone 380 receives voice and inputs voice data to CPU 310. The CPU 310 may receive a user's voice message, such as various information and various commands, and pass the voice message data to the control device 100. Note that the CPU 310 also receives information and instructions from the operation unit 340.

### Configuration of Display Device 500

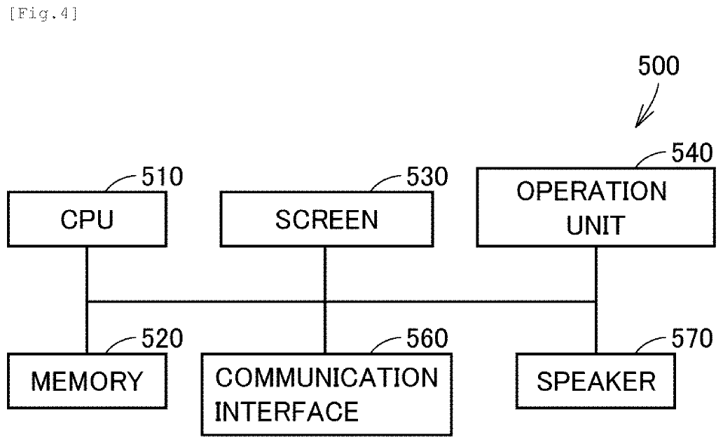

Next, one aspect of the configuration of the display device 500 included in the network system 1 will be described. Referring to FIG. 4, display device 500 according to the present embodiment includes, as main components, CPU 510, memory 520, screen 530, operation unit 540, communication interface 560, speaker 570, and the like.

CPU 510 controls each part of display device 500 by executing programs stored in memory 520.

Memory 520 is implemented by various RAMS, various ROMs, and the like. The memory 520 stores various application programs, data generated by execution of programs by the CPU 510, data input via various interfaces, and the like.

Screen 530 is composed of a plurality of elements, glass, or the like. The screen 530 displays various images, texts, etc. according to instructions from the CPU 510.

Operation unit 540 includes buttons, switches, and the like. The operation unit 540 passes various commands input by the user to the CPU 510. Screen 530 and operation unit 540 may constitute a touch panel.

Communication interface 560 transmits and receives data to and from other devices such as control device 100 via a wired LAN, wireless LAN, mobile communication network, or the like. For example, communication interface 560 receives image signals from control device 100 and transfers them to CPU 510 and screen 530.

Speaker 570 outputs various sounds based on signals from CPU 510. CPU 510 causes speaker 570 to output various sounds based on its own program or judgment, or based on instructions from control device 100.

### Configuration of Robot 600

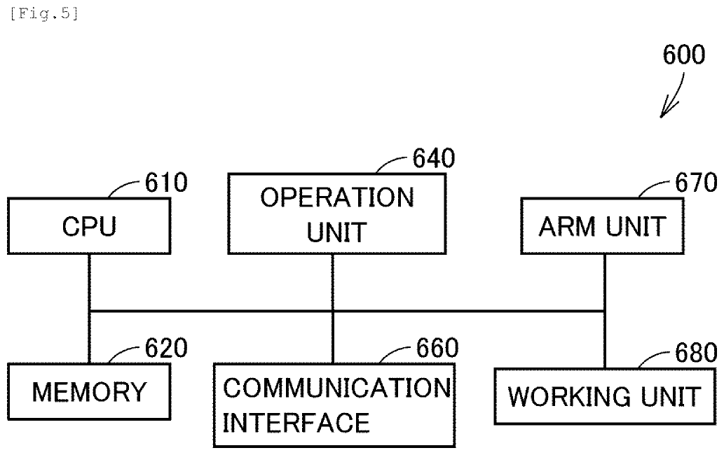

Next, one aspect of the configuration of the robot 600 included in the network system 1 will be described. Referring to FIG. 5, robot 600 according to the present embodiment includes, as main components, CPU 610, memory 620, operation unit 640, communication interface 660, arm unit 670, working unit 680, and the like.

CPU 610 controls each part of the robot 600 by executing various programs stored in the memory 620.

The memory 620 is implemented by various RAMS, various ROMs, and the like. Memory 620 stores various application programs, data generated by execution of programs by CPU 610, operation commands given from control device 100, data input via various interfaces, and the like.

Operation unit 640 includes buttons, switches, and the like. The operation unit 640 transfers various commands input by the user to the CPU 610.

Communication interface 660 transmits and receives data to and from other devices such as control device 100 via a wired LAN, wireless LAN, mobile communication network, or the like. For example, communication interface 660 receives an operation command from control device 100 and passes it to CPU 610.

Arm unit 670 controls the position and orientation of working unit 680 according to instructions from CPU 610.

Working unit 680 performs various operations, such as grasping and releasing an object, according to instructions from CPU 610.

### Information Processing of Control Device 100

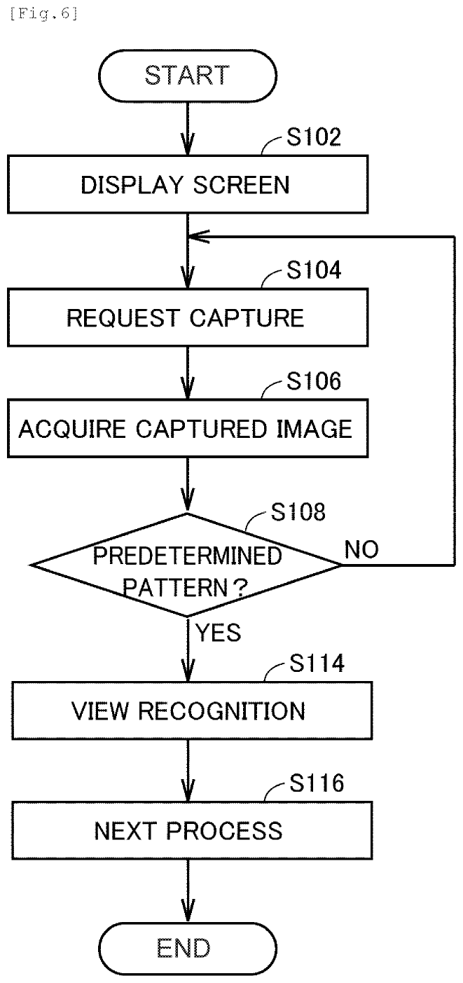

Next, referring to FIG. 6, information processing of control device 100 in the present embodiment will be described in detail. CPU 110 of control device 100 executes the following processing according to the program in memory 120.

First, CPU 110 causes display device 500 to display a predetermined screen via communication interface 160 (step S102). The screen includes an image or text information for showing information for the user or operator to recognize. In addition to the information to be recognized, the screen may include a predetermined image, text, AR marker, or the like that is easy to be identified.

CPU 110 instructs wearable terminal 300 to take an image via communication interface 160 (step S104).

When CPU 110 acquires a captured image from wearable terminal 300 (step S106), CPU 110 determines whether or not the captured image includes a predetermined image, text, AR marker, or the like (step S108).

If the captured image includes information such as a predetermined image, text, or an AR marker (YES in step S108), CPU 110 determines that the user of wearable terminal 300 has viewed or visually recognized the information displayed on the screen (step S114).

CPU 110 executes the following operation (step S116). For example, CPU 110 causes display device 500 to display the next page via communication interface 160.

On the other hand, if the captured image does not contain predetermined information, such as a predetermined image, text, or AR marker (NO in step S108), CPU 110 executes the processing from step S104.

### Second Embodiment

In the above embodiment, it is determined whether or not the user has visually recognized the predetermined information displayed on the screen by determining whether or not the captured image contains the predetermined information. However, the solution is not limited to such forms.

In step S108, CPU 110 may determine whether or not a predetermined area of the captured image contains predetermined information such as a predetermined image, text, or an AR marker. For example, the predetermined area is the central portion of the image. Then, when the central portion of the captured image contains predetermined information such as a predetermined image, text, or an AR marker (YES in step S108), the CPU 110 may determine that the user has visually recognized the predetermined information displayed on the screen (step S114).

### Third Embodiment

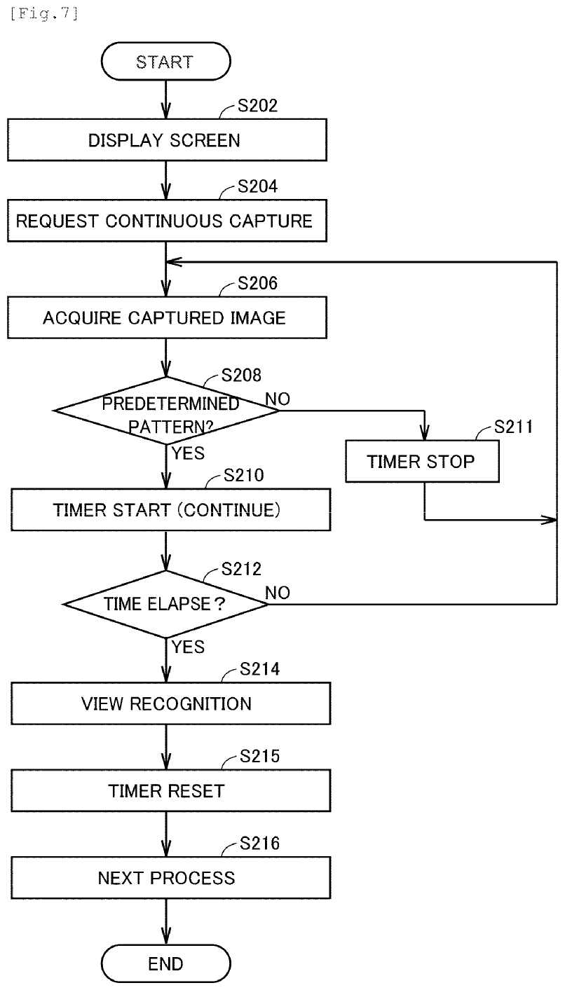

Alternatively, as shown in FIG. 7, when the wearable terminal 300 captures predetermined information such as a predetermined image, text, or an AR marker for a predetermined time or longer, CPU 110 may determine that the user has visually recognized the predetermined information displayed on the screen. That is, when the predetermined information such as the predetermined image, text, or an AR marker appears in the captured image for a predetermined time or longer, the CPU 110 determines that the predetermined information displayed on the screen has been visually recognized by the user.

More specifically, referring to FIG. 7, CPU 110 causes display device 500 to display a predetermined screen via communication interface 160 (step S202). The screen includes predetermined information, such as a predetermined image, text, or AR marker.

CPU 110 commands wearable terminal 300 to shoot a moving image via communication interface 160 (step S204).

When CPU 110 acquires a captured image from wearable terminal 300 (step S206), CPU 110 determines whether the captured image includes predetermined information such as a predetermined image, text, or an AR marker (step S208).

If the captured image includes predetermined information, such as a predetermined image, text, or AR marker (YES in step S208), CPU 110 starts a timer (step S210). If the timer is already counting, the CPU 110 continues counting.

If the captured image does not contain predetermined information such as a predetermined image, text, or AR marker (NO in step S208), CPU 110 stops the timer (step S211). At this timing, the CPU 110 may reset the timer.

While repeating the processing from step S206, CPU 110 determines whether or not the period in which the captured image includes predetermined information reaches a predetermined time, such as 5 seconds (step S212).

When the period in which the captured image contains the predetermined information reaches the predetermined time (YES in step S212), CPU 110 determines that the user wearing wearable terminal 300 has visually recognized the information displayed on the screen (step S214).

CPU 110 resets the timer (step S215) and executes the next operation (step S216). For example, CPU 110 causes display device 500 to display the next page via communication interface 160.

Note that in the present embodiment, wearable terminal 300 captures moving images, and control device 100 sequentially acquires moving image data from wearable terminal 300. Wearable terminal 300 may provide still image data to control device 100 intermittently, for example, every 0.2 seconds.

### Fourth Embodiment

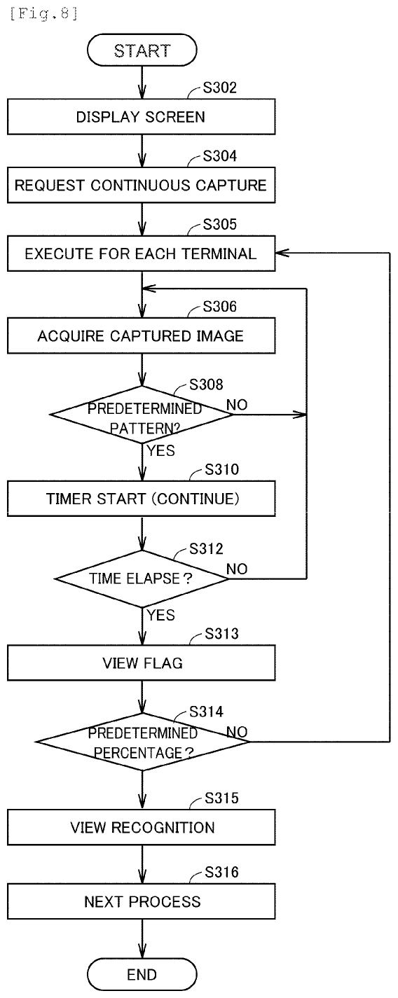

In the above embodiment, the CPU 110 determines whether or not one user wearing one wearable terminal 300 visually recognizes predetermined information, such as a predetermined image, text, or AR marker. The solution is not limited to the form described above. For example, as shown in FIG. 8, when the predetermined information appears in a plurality of captured images captured by a plurality of wearable terminals 300, CPU 110 may determine that a plurality of users have visually recognized predetermined information displayed on the screen.

More specifically, CPU 110 causes display device 500 to display a predetermined screen via communication interface 160 (step S302). The screen includes predetermined information such as a predetermined image, text, or AR marker.

CPU 110 commands a plurality of wearable terminals 300 to shoot moving images via communication interface 160 (step S304).

CPU 110 executes the following process for each of the plurality of wearable terminals 300 (step S305). In other words, CPU 110 proceeds the following process for the plurality of wearable terminals 300 in parallel.

When CPU 110 acquires a captured image from one wearable terminal 300 (step S306), CPU 110 determines whether predetermined information is included in the captured image (step S308).

If the captured image contains predetermined information (YES in step S308), CPU 110 starts one timer (step S310). If the timer is already counting, the CPU 110 causes the timer to continue counting.

If the captured image does not contain the predetermined information (NO in step S308), CPU 110 stops or resets the timer and repeats the process from step S306.

While repeating the processing from step S306, CPU 110 determines whether or not the period in which predetermined information is included in the captured image has reached a predetermined time, such as 5 seconds (step S312).

When the period in which the captured image contains the predetermined information reaches the predetermined time (YES in step S312), CPU 110 sets a recognition flag for the target wearable terminal 300 (step S313).

CPU 110 repeats the process from step S305 for a plurality of wearable terminals 300 until the visual recognition flags for a predetermined percentage of wearable terminals 300 are set (step S314).

When the visibility flag is set for a predetermined percentage of wearable terminals 300 (YES in step S314), CPU 110 determines that the users has visually recognized a predetermined image or text (step S315). CPU110 executes the following operation (step S316). For example, CPU 110 causes display device 500 to display the next page via communication interface 160.

### Fifth Embodiment

In addition to the above embodiment, when the image on the screen of display device 500 visible from wearable terminal 300, text, or predetermined information such as an AR marker is small, the control device 100 may cause the display device 500 to display an enlarged predetermined image or text. When the display device 500 displays a predetermined image, text, or AR marker that is different from the information to be recognized by the user and is easily identifiable, the size of the information to be recognized by the user and the size of the information for identification are preferably set with at a predetermined ratio.

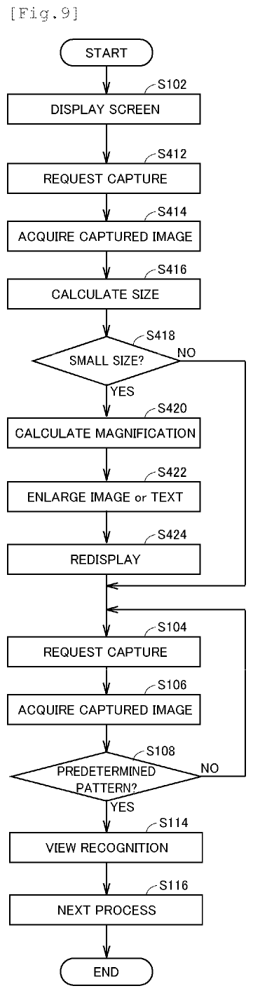

More specifically, as shown in FIG. 9, CPU 110 causes display device 500 to display a predetermined screen via communication interface 160 (step S102). The screen includes predetermined information such as a predetermined image, text, or AR marker.

CPU 110 instructs wearable terminal 300 to take an image via communication interface 160 (step S412).

When the CPU 110 acquires the captured image from the wearable terminal 300 (step S414), the CPU 110 calculates the size of the image or text to be displayed on the screen based on the size of the image, text, or AR marker in the captured image (step S416).

CPU 110 determines whether the size of the image, text, or predetermined image or text is smaller than a predetermined value (step S418).

When the size of predetermined information such as an image, text, predetermined image, text, or AR marker is smaller than a predetermined value (YES in step S418), the CPU 110 calculates an enlargement rate so that the size is larger than a predetermined value (step S420).

The CPU 110 creates a screen in which the image and the text to be displayed on the screen and to be visually recognized by the user are enlarged at the enlargement ratio. At this time, if the identification image, text, or AR marker is displayed, not only the information to be visually recognized but also the identification information is enlarged by the same magnification (step S422).

CPU 110 causes display device 500 to display the enlarged screen by transmitting the enlarged screen to display device 500 via communication interface 160 (step S424).

CPU 110 instructs wearable terminal 300 to take an image via communication interface 160 (step S104).

When CPU 110 acquires a captured image from wearable terminal 300 (step S106), CPU 110 determines whether or not the captured image includes a predetermined image, text, or an AR marker (step S108).

If the captured image includes predetermined information such as a predetermined image, text, or an AR marker (YES in step S108), CPU 110 determines that the user of wearable terminal 300 has visually recognized a predetermined image or text (step S114).

CPU 110 executes the following operation (step S116). For example, CPU 110 causes display device 500 to display the next page via communication interface 160.

On the other hand, if the captured image does not contain predetermined information such as a predetermined image, text, or AR marker (NO in step S108), CPU 110 executes the process from step S104.

### Sixth Embodiment

In the above embodiment, display device 500 displays predetermined information such as a predetermined image, text, or an AR marker. However, the predetermined information is not limited to what is displayed on display device 500. That is, the predetermined information may be displayed on another device or in another location.

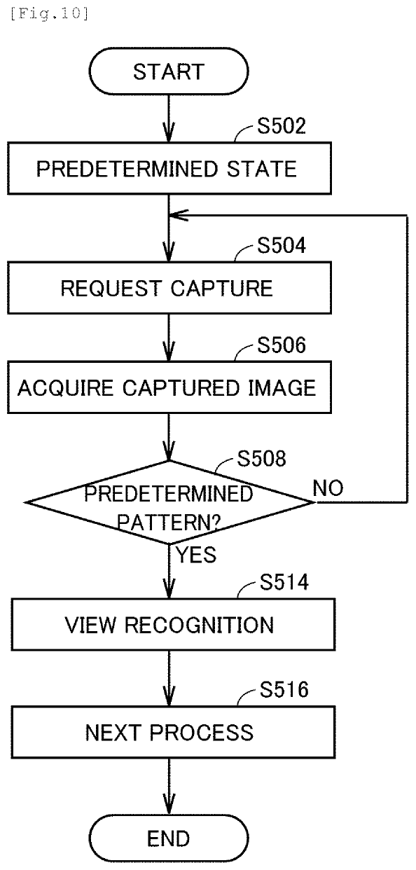

For example, referring to FIG. 10, when a predetermined condition is satisfied (YES at step S502), for example, when robot 600 performs a predetermined action (YES at step S502), the CPU 110 executes the process from step S504.

CPU 110 instructs wearable terminal 300 to take an image via communication interface 160 (step S504).

When CPU 110 acquires a captured image from wearable terminal 300 (step S506), CPU 110 determines whether or not the captured image includes predetermined information such as an image indicating a predetermined state, text, or an AR marker (step S508).

If the captured image contains predetermined information such as an image indicating a predetermined state, text, or an AR marker (YES in step S508), CPU 110 determines that the user of wearable terminal 300 has visually recognized the object on which the identification information is displayed or printed (step S514).

CPU 110 executes the following operation (step S516). For example, CPU 110 causes robot 600 to perform the following operations via communication interface 160.

On the other hand, if the captured image does not contain predetermined information such as an image indicating a predetermined state, text, or an AR marker (NO in step S508), CPU 110 executes the process from step S504.

### Seventh Embodiment

In the above embodiment, the user's visual recognition is determined by displaying predetermined information such as a predetermined image, text, or AR marker on the display device 500 or the target object. However, the predetermined information is not limited to images, text, or AR markers. For example, the CPU 110 may determine that the user has visually recognized the state when a robot, device, or part in a predetermined state appears in the captured image.

Referring to FIG. 10, when a predetermined condition is satisfied (YES at step S502), for example, when robot 600 performs a predetermined action (YES at step S502), the CPU 110 executes the process from step S504.

CPU 110 instructs wearable terminal 300 to take an image via communication interface 160 (step S504).

When the CPU 110 acquires the captured image from the wearable terminal 300 (step S506), the CPU 110 determines whether the captured image includes a predetermined AR marker printed on each part of the robot 600 or a display device such as an LED lighting with a different color for each part installed on each part (Step S508). Alternatively, CPU 110 determines whether a plurality of such pieces of identification information are included in the captured image (Step S508). In this way, the CPU 110 determines that the user has visually recognized the predetermined state of the robot 600 (Step S514).

CPU 110 executes the following operation (step S516). For example, CPU 110 causes robot 600 to perform the following operations via communication interface 160.

On the other hand, if NO in step S508, CPU 110 executes the process from step S504.

### Eighth Embodiment

Other devices may perform part or all of the role of each device such as the control device 100, the wearable terminal 300, the display device 500, and the robot 600 of the network system 1 of the above embodiment. For example, wearable terminal 300 may play a part of the role of control device 100. A plurality of personal computers may play the role of the control device 100. Information processing of the control device 100 may be executed by a plurality of servers on the cloud.

### Review

The foregoing embodiments provide a network system that includes a wearable terminal having a camera and wearable by a user and a control device capable of communicating with the wearable terminal. The wearable terminal transmits the image captured by the camera to the control device. The control device determines whether or not a predetermined information has been viewed by the user based on the image.

Preferably, the network system further comprises a display. The control device determines that the predetermined information has been viewed by the user when the image includes a specified object displayed by the display.

Preferably, the control device determines that the predetermined information has been viewed by the user when a specified object appears in a specified area of the image.

Preferably, the control device determines that the predetermined information has been viewed by the user when a specified amount of time has passed while a specified object appears in the image.

Preferably, the network system further comprises a plurality of wearable terminals worn by a plurality of users respectively. The control device determines that the predetermined information has been viewed by the user when a specified object appears in a predetermined number or more of the plurality of images received from the plurality of the wearable terminals.

Preferably, the network system further comprises a display. The control device determines that the predetermined information has been viewed by the user when the image includes a specified object displayed by the display. The control device adjusts the size of the specified objects displayed on the display based on the image.

The foregoing embodiments provide an information processing method comprising a wearable terminal worn by a user capturing an image with a camera and a control device determining whether or not a predetermined information has been viewed by the user based on the captured image.

The foregoing embodiments provide a control device comprising a communication interface for communicating with a wearable terminal and a processor for receiving a captured image from the wearable terminal via the communication interface and determining whether or not a predetermined information has been viewed by a user based on the captured image.

The embodiments disclosed herein are to be considered in all aspects only as illustrative and not restrictive. The scope of the present invention is to be determined by the scope of the appended claims, not by the foregoing descriptions, and the invention is intended to cover all modifications falling within the equivalent meaning and scope of the claims set forth below.

What is claimed is:

1. A network system comprising:
a wearable terminal having a camera and wearable by a user; and
a control device capable of communicating with the wearable terminal, wherein:
the wearable terminal transmits the image captured by the camera to the control device, and
the control device determines whether or not a predetermined information has been viewed by the user based on the image.

2. The network system according to claim 1, further comprising a display, wherein the control device determines that the predetermined information has been viewed by the user when the image includes a specified object displayed by the display.

3. The network system according to claim 1, wherein the control device determines that the predetermined information has been viewed by the user when a specified object appears in a specified area of the image.

4. The network system according to claim 1, wherein the control device determines that the predetermined information has been viewed by the user when a specified amount of time has passed while a specified object appears in the image.

5. The network system according to claim 1, further comprising a plurality of wearable terminals worn by a plurality of users respectively, wherein the control device determines that the predetermined information has been viewed by the user when a specified object appears in a predetermined number or more of the plurality of images received from the plurality of the wearable terminals.

6. The network system according to claim 1, further comprising a display, wherein:
the control device determines that the predetermined information has been viewed by the user when the image includes a specified object displayed by the display, and
the control device adjusts the size of the specified objects displayed on the display based on the image.

7. An information processing method comprising:
a wearable terminal worn by a user capturing an image with a camera, and
a control device determining whether or not a predetermined information has been viewed by the user based on the captured image.

8. A control device comprising:
a communication interface for communicating with a wearable terminal; and
a processor for receiving a captured image from the wearable terminal via the communication interface and determining whether or not a predetermined information has been viewed by a user based on the captured image.
